(19) United States
(12) Patent Application Publication
(10) Pub. No.: US 2008/0063763 A1
(43) Pub. Date: Mar. 13, 2008

(54) METHOD FOR MANUFACTURING TASTELESS AND CLEAN SMOKE FOR SEAFOOD PRESERVATION

(76) Inventor: Ernie Balbutin Calamian, Puerto Princesa (PH)

Correspondence Address: Carl D. Crowell, P.O. Box 923, Salem, OR, 97308-0923, US

(21) Appl. No.: 11/530,902

(22) Filed: Sep. 12, 2006

(51) Int. Cl. A23B 4/052

(52) U.S. Cl. 426/314; 426/643

(57) ABSTRACT

A method creating tasteless and clean smoke from the combustion of wood or other organic fuel. The smoke is filtered by bubbling it through a combination of water and reactive filter elements held inside a series of filtering tanks. The water and filter elements encapsulate, bind, and otherwise remove undesired elements of the smoke. The carbon monoxide lost due to oxidation with water during filtration is restored in a recovery tank where a reducing solution is used to recover oxidized carbon monoxide. The resulting smoke is tasteless and clean. In addition, the resulting smoke is stripped of undesirable substances and is suitable for use in the treatment and preservation of raw seafood with sufficient concentrations of preservative carbon monoxide for effective use.

### BACKGROUND

This invention relates to a method of preserving seafood, specifically to a method and apparatus for generating and filtering smoke to produce a clean unflavored smoke for use in treating raw seafood to preserve its freshness from fresh catch to consumption.

Nature reclaims all living things through decomposition. Oxidation, where oxygen interacts with cells causing them to deteriorate, and microbial decomposition, where microbes consume cells, begins almost immediately after an animal dies. In seafood and other meats the natural process of decomposition causes putridity making the product unsafe to eat.

Myoglobin is a protein in muscle cells that carries oxygen. A molecule of myoglobin contains a heme, with an iron atom at its center, and a globular protein portion. Myoglobin transports oxygen from the blood stream to and through muscle tissue by allowing oxygen to reversibly attach to its heme. The color of myoglobin results, in part, from the oxidative state of the iron within.

In seafood and other meats, color is affected by the amount and oxidative state of myoglobin present in the muscle. The amount of myoglobin is dependant on the species of animal, its age, and its muscle activity. The oxidative state of myoglobin depends on what substance or substances the myoglobin has combined with. Myoglobin reacts with the oxygen to form oxymyoglobin which is bright red. Thus, fresh raw seafood exposed to air becomes red in color due to the creation of oxymyoglobin. However, raw seafood will not maintain its freshness or fresh color unless its decomposition and color degradation is controlled.

Since the invention of refrigeration, the decomposition of seafood and other meats has commonly been controlled by storing the products in a frozen environment, typically ranging from −34° F. (−37° C.) to 0° F. (−18° C.). In this environment however, the oxymyoglobin formed from exposure to air, can still oxidize to form a brown substance called metmyoglobin. This in turn makes raw seafood an undesirable and unappetizing brown. While decomposition, caused by oxidation or microbes, can be controlled for relatively long periods of time through freezing, the formation of metmyoglobin and the associated browning is inevitable at this temperature range. In warmer environments seafood decomposes rapidly.

Freezing seafood at temperatures below −76° F. (−60° C.) is common in Japan. At −76° F. (−60° C.) or below, oxymyoglobin is prevented from forming metmyoglobin and thus remains red in color. However, to distribute and store seafood at this low a temperature requires a massive infrastructure which the Japanese have built perhaps, in part, because sashimi, a raw seafood staple of Japanese cuisine, requires a method that preserves color while controlling decomposition. This infrastructure is not easily replicated as an entire system of manufacturing, distribution, and storage must be built or modified to maintain a significantly lower temperature.

Myoglobin can combine with compounds besides oxygen. Cold smoke, or smoke that is cooled to prevent cooking the seafood during smoking, is such a compound. In fact, the seafood industry commonly treats raw seafood with cold smoke. Reacting myoglobin with cold smoke, results in red coloring much like the color from an oxygen reaction and forms a type of myoglobin that is stable at typical freezer temperatures. As such, frozen seafood that is treated with cold smoke does not turn brown and retains a fresh red color at temperatures supplied by typical storage and distribution facilities (i.e. those which store seafood above −76° F.).

Such smoke also has constituent antimicrobial elements that reduce the number of microbes that would otherwise speed decomposition of raw seafood, and has antioxidants that help to prevent raw seafood from becoming rancid. Furthermore, the carbon monoxide and carbon dioxide found in the smoke lowers the pH of seafood, further extending the shelf life of treated raw seafood.

In the seafood industry, smoke for seafood preservation is generated by burning organic material, typically wood. The result of this combustion is a hot combination of various gases and particulate matter. Particulate matter like ash and taste imparting substances are undesirable and are filtered out of the smoke or reduced to a concentration where they cannot be tasted. The filtered or cleaned smoke is then cooled because hot smoke would cook the seafood. Lastly, the cold clean smoke is used to treat raw seafood, resulting in a seafood product with extended shelf life.

The seafood industry has come to refer to such cold clean smoke obtained through filtering the smoke from burning wood as tasteless smoke, and there are various known ways to manufacture it. With respective novelties, U.S. Pat. No. 5,484,619 and U.S. Pat. No. 5,972,401 disclose methods of filtering and cooling smoke from the combustion of organic material to form tasteless smoke.

The earlier method disclosed by U.S. Pat. No. 5,484,619 uses smoke from burning wood in a combustion chamber attached to a filtering unit. The filtering unit contains a number of filters in series. Undesired elements of combustion are removed by being trapped in the filters as the smoke passes through the filtering unit.

After the smoke is filtered it is cooled by flowing through a pipe submersed in a cooling tank filed with a cooling liquid. The cooling liquid is kept at or slightly below 32° F. (0° C.), causing the hot smoke to emerge from the cooling tank at or slightly above 32° F. (0° C.). Raw seafood is kept in a smoking chamber. Cold smoke from the cooling tank is piped into the smoking chamber where it saturates the raw seafood imparting the smoke's preservative effects on the seafood.

The resulting filtered wood smoke, or tasteless smoke is then applied to meat to treat the meat without imparting a smoky taste. The result is when use with fish, the treated fish may still be used as sushi or sashimi as if it were fresh.

A later method disclosed by U.S. Pat. No. 5,972,401 also uses smoke from burning wood in a combustion chamber attached to a filtering unit. The improvements of this '401 technology relate to a filtering which passes smoke through a column of crushed ice. The hot smoke is cooled as it passes through the ice. Likewise, ice is vaporized into steam and melted into water by the hot smoke. Particulate matter is encapsulated by water from the vaporized ice is allowed to precipitate downward to a residue reservoir. The steam helps this filtering by increasing humidity, making the particulate matter heavier and more adhesive. The carbon and cloth filters complete the filtering process by trapping the remaining particulate matter and reducing odor and taste imparting substances to imperceptible levels.

Here, even though filters are not the only method relied on to clean smoke, the use of such filters includes the associated drawbacks of filters, namely, the expense in regularly maintaining and replacing filters. In addition, this method, by using water in the form of ice, causes oxidation which increases the amount of carbon dioxide while decreasing the amount carbon monoxide in smoke. This method also suffers from requiring large amounts of ice and producing reduced concentrations of carbon monoxide.

Other water based methods of filtering include bubbling smoke through water or a water vapor wash. These methods also heavily rely on the use of carbon and cloth filters with their associated expense and maintenance requirements. As with the ice based method above, the reaction with water oxidizes elements of smoke altering the ratio of carbon monoxide to carbon dioxide that would otherwise be found.

Of the usual constituent elements of smoke, the primary desired compounds are the carbon monoxide, nitric oxide, and nitrogen dioxide that react with myoglobin to form a red compound stable at the ordinary freezer temperatures discussed above.

Tasteless smoke is widely used because the concentrations of its constituent elements are such that the decomposition of raw seafood can be significantly controlled while maintaining a natural red coloring accurately approximating that of fresh seafood. For example, treatment with high concentrations of carbon monoxide or carbon monoxide alone can induce a redness of raw tuna that does not fade naturally as found in fresh tuna.

However, many methods of producing filtered wood smoke, such as the '401 patent issued to Kowalski, rely heavily on ice and water systems that reduce the levels of carbon monoxide and producing concentrations of carbon monoxide in concentrations that permit effective treatment of meat may be difficult.

What is herein desired and disclosed is an improved method of manufacturing smoke for use in preserving the freshness of meat without imparting any flavor to the meat while substantially maintaining the concentrations of constituent elements obtained from combustion. The specific improvements of this invention relate to an enhanced water based filtering method that recovers carbon monoxide lost to oxidation with water while eliminating or substantially reducing the need for additional filters.

### SUMMARY OF THE INVENTION

When wood is sufficiently heated, the heat causes a reaction that produces a gaseous mixture known as smoke, consisting of carbon dioxide, carbon monoxide, nitrogen, phenols, various hydrocarbons, particulate matter, and other substances. This reaction leaves char and ash behind. Ash is a mixture of the unburnable minerals that are in wood such as calcium and potassium. Char, is basically pure carbon which produces carbon dioxide when burned.

The subject of this invention is a method of filtering smoke by bubbling it through an enhanced water filter and then through a caustic, preferably aqueous sodium hydroxide-solution to produce a tasteless and clean preservative smoke. In the preferred embodiment, the water filter is a bubble tank which holds water and reactive filter elements. A pipe or tube with bubblers near the bottom of the tank releases the smoke in bubbles that then float through the tank, where they are collected at the top of the bubble tank.

Bubbling smoke through the filter increases the amount of surface contact between the smoke, the water, and the submerged reactive filter elements. The water encapsulates particulate matter present in the smoke thereby removing it from the smoke. The water also dissolves certain polar compounds in the smoke, such as the flavor inducing glucose found in wood in the form of cellulose molecules. Meanwhile the reactive filter elements attract hydrocarbons in the smoke, binding them to the surface of the filter element and thereby preventing unwanted hydrocarbons from remaining in the smoke as it bubbles through the enhanced water filter.

A further improvement includes the use of bubble tank with a non-polar aqueous filter, such as ethanol, and a bubble tank with a chlorinated aqueous filter to further reduce odor imparting elements.

The antioxidant phenols and antimicrobial compounds which control decomposition, as well as the freshness and color preserving carbon monoxide and carbon dioxide remain in the smoke while unwanted substances are filtered out. After the filtering process is completed the smoke is substantially clean. Carbon or cloth filters may be used later to further clean and remove flavor from the smoke if desired. However, the reactive filter elements in the water eliminate or greatly reduce the need for additional filtration.

It should be noted that a filter tanks or bubble tanks of this type is easily maintained. The water is drained and the used filter elements removed. Clean water and new filter elements are then used to refill the tank. The walls of the filter tank may be cleaned while it is empty if this is necessary. After these steps are complete the filter tank is restored and ready to filter more smoke.

I primary improvement in the present method is the use of a caustic, or reducing filter tank for recovery of oxidized carbon monoxide. The interaction between the smoke bubbles and the water oxidizes the smoke which increases the amount of carbon dioxide while decreasing the amount of carbon monoxide. This alters the ratio between carbon monoxide and carbon dioxide in the smoke. To restore the ratio, the filtered smoke is bubbled through a recovery tank.

The recovery tank contains a caustic aqueous reducing solution such as sodium hydroxide and, like the filter tank, a pipe or tube with bubblers. When filtered smoke is bubbled through the reducing solution, the ratio between carbon monoxide and carbon dioxide is substantially restored because the oxidized carbon monoxide (carbon dioxide) is reduced back to usable carbon monoxide.

The resulting smoke is tasteless and clean and may be used to treat raw seafood in any method that allows the raw seafood to be sufficiently exposed to the smoke in a manner sufficient to allow the smoke to permeate through the raw seafood. Typically, treatment of seafood will occur in bags where raw seafood is exposed to the tasteless and clean smoke for several hours while under refrigeration. The bags may be pressurized to allow the smoke to better permeate the raw seafood.

### BRIEF DESCRIPTION OF THE DRAWINGS

FIG. 1 shows the filtration and recovery system.

FIG. 2 shows a smoke manufacturing apparatus with the filtration and recovery system.

FIG. 3 is a perspective view of an individual filtering element.

FIG. 4 is a perspective view of a bubbler.

FIG. 5 shows the carbon filter of the alternate embodiment.

FIG. 6 shows the cooling unit of the alternate embodiment.

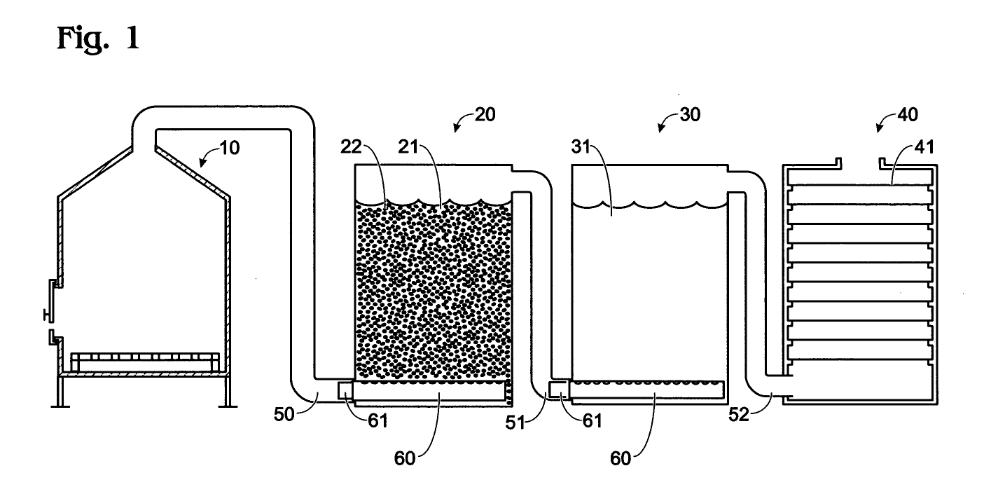

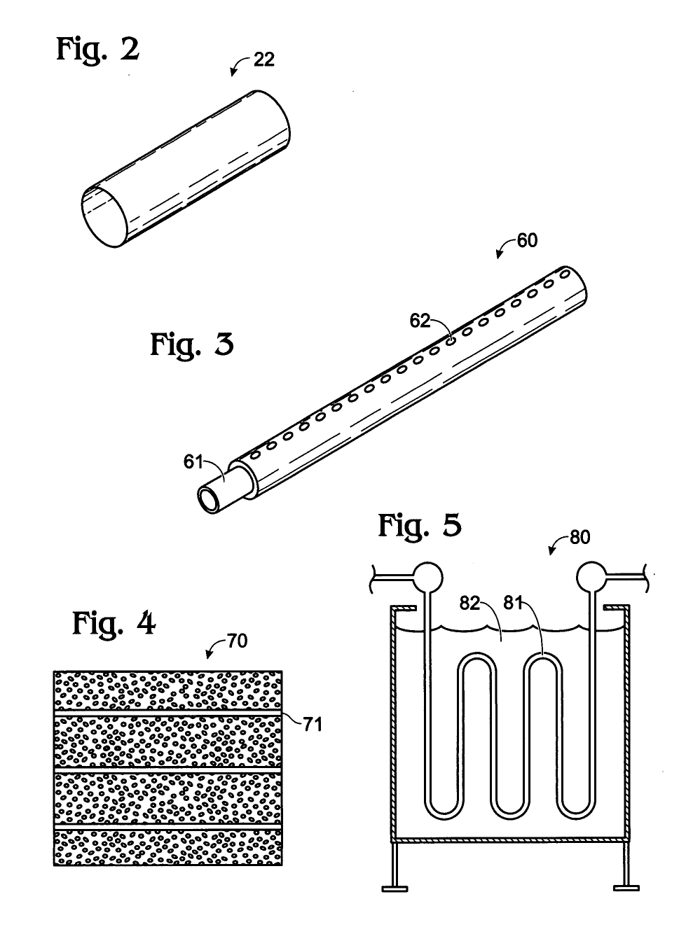

### PREFERRED EMBODIMENT OF THE INVENTION

In the preferred embodiment, the filtration and recovery subsystem consist of a filter tank 20 and a recovery tank 30. The filter tank 20 is filled with water 21 and individual filter elements 22. The filter elements 22 may be of any number of shapes and sizes, though in the preferred embodiment, due to economy and effectiveness, small sections of plastic type straws of approximately 1 cm in length are used, having a large amount of surface area and relative low cost. Near the bottom of the filter tank 20 is a bubbler 60. The bubbler 60 is a hollow cylindrical device with a series of holes 62 arranged along the bubbler's 60 length. One end of the bubbler 60 is capped while the other end has an inlet 61 to allow gas into the bubbler 60.

A filter inlet pipe 50 leads into the filter tank 20. Smoke is sent into the filter tank 20 through the filter inlet pipe 50. The bubbler's 60 inlet 61 is connected to the filter inlet pipe 50. Once in the filter tank 20, smoke is bubbled through the water 21 and filter elements 22 in the filter tank 20. Smoke bubbles are formed when the smoke passes through the series of holes 62 in the bubbler 60. As the smoke bubbles pass through the water 21 and filter elements 22 particulate matter is encapsulated by the water 21 and removed from the smoke. Polar compounds are dissolved by the water 21 while the filter elements 22 attract and remove the hydrocarbons in the smoke. The smoke bubbles float up from the bubbler 60 to the top of the filter tank 20 where they escape the water 21 and filter elements 22. The smoke is tasteless and clean at this point and collects in the space between the water 21 and the top of the filter tank 20. The process of bubbling the smoke through the water 21 also cools the smoke.

The tasteless and clean smoke is forced out of the filter tank 20 by pressure or mechanical means and into the recovery tank 30 through the recovery inlet pipe 51.

Though a single filter tank may be used, it may be desirable to use two or more filter tanks in series to provide added filtration and to extend the duration of the filters between cleanings.

After the filtration of the filter tank(s) 20, the recovery inlet pipe allows the smoke from the (final) filter tank 20 to enter the recovery tank 30. The recovery tank 30 is filled with an aqueous reducing solution such as caustic sodium hydroxide 31. A bubbler 60 is located near the bottom of the tank. This bubbler's 60 inlet 61 is connected to the recovery inlet pipe 51. In the preferred embodiment, tasteless and clean smoke from the filter tank 20 passes into the recovery tank's 30 bubbler 60 and is bubbled through the reducing solution 31.

As the tasteless and clean smoke bubbles float up through the recovery tank 30, the reducing solution 31 recovers carbon monoxide lost to oxidation with the water 21 in the filter tank 20. The carbon monoxide recovered by the reducing solution 31 restores the ratio of carbon monoxide to carbon dioxide such that it is substantially similar to the ratio found in the original smoke. The tasteless and clean smoke bubbles float upward escaping the reducing solution 31 to collect between the reducing solution 31 and the top of the recovery tank 30. Pressure or mechanical means forces the tasteless and clean smoke out of the recovery tank 30 into the tasteless and clean smoke outlet pipe 52. The tasteless and clean smoke leaving the recovery tank 30 is ready to be used for the treatment of raw seafood.

A further improvement includes the use of bubble tank with a non-polar aqueous filter, such as ethanol, and a bubble tank with a chlorinated aqueous filter to further reduce odor imparting elements. The structure of these tanks is similar to the structure of the filter and recovery tanks, including a bubbler at the bottom of a bubble tank for releasing the smoke into the tank and collection at the top of the tank.

In the preferred embodiment smoke is generated in a combustion chamber 10 where wood or other organic fuel is heated to a controlled temperature to allow smoke with the desired preservative, antioxidant, and antimicrobial constituent elements to be created while minimizing undesired elements. To treat the raw seafood with tasteless and clean smoke, the preferred embodiment utilizes plastic type bags into which the raw seafood is placed, and then the bags are filled with tasteless and clean smoke and sealed. Raw seafood is exposed to the tasteless and clean smoke, preferably under refrigeration, until the desired preservative qualities are absorbed by the raw seafood. Once treatment is complete, the raw seafood may repackaged, if necessary, and frozen for transport or sale, though it is also desirable at times for the raw seafood to remain in an unfrozen state for sale as fresh.

In an alternate embodiment additional filtration may be added by attaching a carbon filter 70 to the filter tank 20 or to the recovery tank 30. The carbon filter 70 contains activated carbon that further captures undesired elements of the smoke before it is used to treat seafood. The carbon filter may also employ cloth filters to better capture undesired elements.

1. A method of smoke filtration and recovery comprising the steps of:
a) passing smoke through an at least one filter tank comprising water;
b) passing smoke through a recovery tank comprising a reducing solution;

2. The method of smoke filtration and recovery of claim 1 wherein said smoke is filtered through said at last one filter tank containing a multitude of filter elements submersed in said water.

3. The method of smoke filtration and recovery of claim 1 further comprising the step of filtering said smoke through a carbon filter.

4. The method of smoke filtration and recovery of claim 3 wherein said smoke is filtered through said carbon filter containing cloth filters.

5. The method of smoke filtration and recovery of claim 1 further comprising the step of filtering said smoke through a filter tank containing a non-polar aqueous solution.

6. The method of smoke filtration and recovery of claim 1 further comprising the step of filtering said smoke through a filter tank containing a chlorinated aqueous solution.
